(19) United States
(12) Patent Application Publication
(10) Pub. No.: US 2023/0205394 A1
(43) Pub. Date: Jun. 29, 2023

(54) Jukebox menu module

(71) Applicant: Reggie Dale Harmon, Breckenridge, CO (US)

(72) Inventor: Reggie Dale Harmon, Breckenridge, CO (US)

(21) Appl. No.: 17/803,494

(22) Filed: Aug. 5, 2022

Related U.S. Application Data
(60) Provisional application No. 63/361,218, filed on Dec. 3, 2021.

(51) Int. Cl. G06F 3/0482; G06F 3/03; G11B 33/12

(52) U.S. Cl. CPC G06F 3/0482; G06F 3/03; G11B 33/123

(57) ABSTRACT

The Jukebox Menu Module provides an improved means to view record or compact disc titles on jukeboxes that utilize a mechanical display system for seeing available music tracks. Thru a video display, the jukebox menu module displays compact disc or record content in the jukebox and allows the user to create, edit and view the content easily without the need to modify any of the wiring or functions of the jukebox itself. It simply replaces the existing original equipment, which is a mechanical module. Once the Jukebox Menu Module is installed, the jukebox menu buttons are used to change the video pages in a similar manner as the mechanical module flipped physical pages.

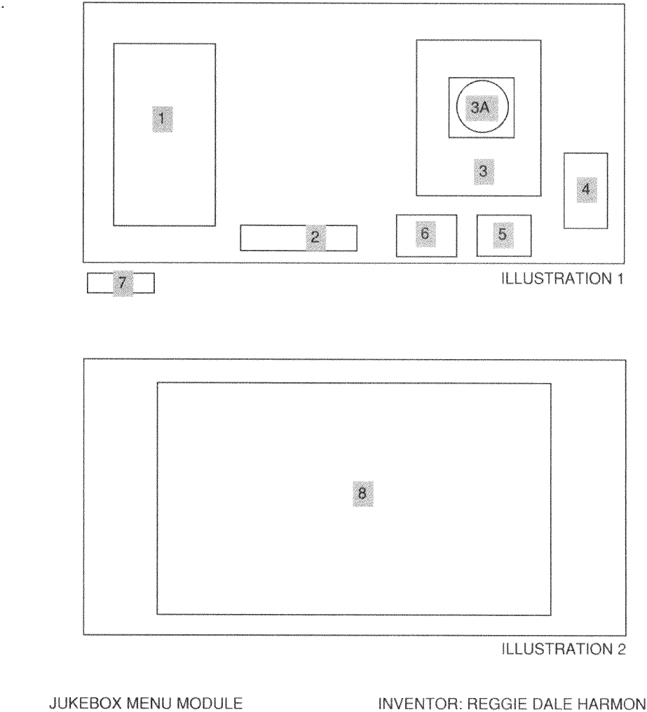

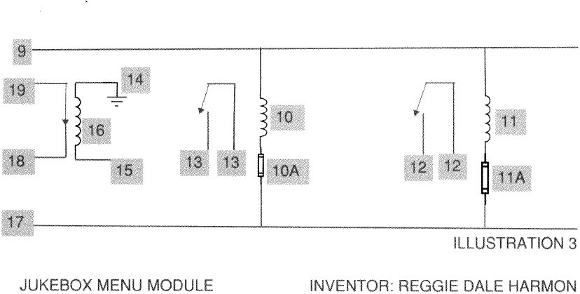

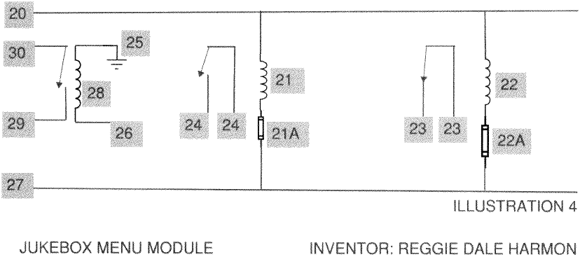

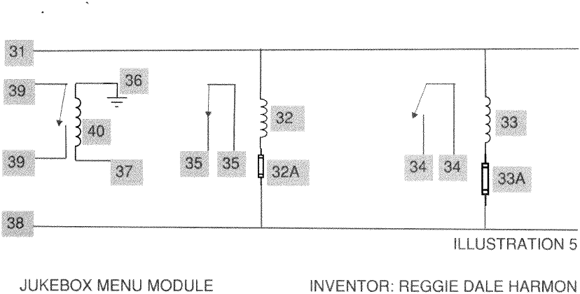

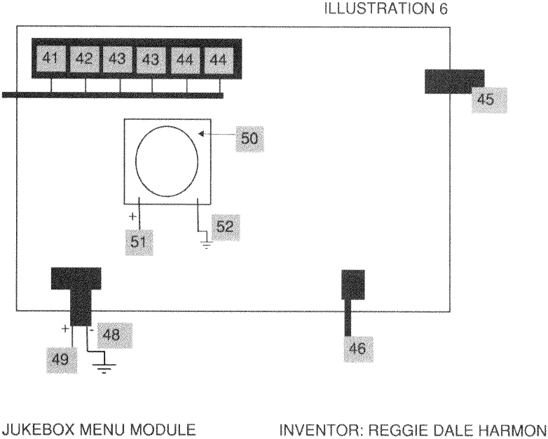

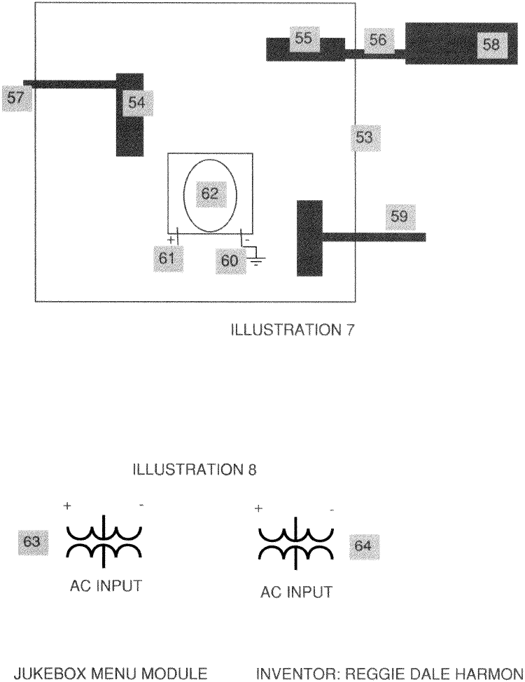

### PRIORITY CLAIM

This application claims priority from Provisional Patent Application No. 63/361,218 filed pro se on Dec. 03, 2021, entitled “Jukebox Menu Module”.

### Field of Invention

This invention relates generally to jukeboxes and more specifically, to jukebox interfaces.

### BACKGROUND OF INVENTION

After purchasing a Rock-Ola CD jukebox it was found that the P2129 mechanical display module could not list all the available tracks on CDs and if it was desired to completely fill the jukebox with 100 CDs that the paper menus have very small print and become unreadable. In addition, the mechanical module is subject to bands stretching or breaking or other mechanical failure. It was desired to have a solution which required no modification to the existing jukebox cabinet or wiring. In searching prior art, CPCI G 07 F 17/305 was most applicable but also G 11 B 17/22, G 11 B 23/40, G 11 B 27/002, G 11 B 33/10 and G 11 B 2220/2545.

### SUMMARY OF THE INVENTION

In order to create a better way to display title tracks on CDs installed in the jukebox, it was decided to create an electronic display module. This module replaces the existing module on jukeboxes using the P2129 mechanical module or equivalent without any modification to the jukebox’s cabinet or wiring which is unique in design.

The P2129 or equivalent mechanical module has been in use for decades and is still in use today.

The invention utilizes the existing forward and back menu buttons on the jukebox for its interface and thus turns the video pages on the display. It keeps the same function and feeling of the original mechanical module.

Simply unplug the OEM mechanical module and plug in the invention. The invention fits into the jukebox and looks like it was an OEM module.

The end user can easily create custom menus with endless possibilities to conform to their music collection using a computer or tablet.

### BRIEF DESCRIPTION OF THE DRAWINGS

The preferred and alternative embodiments of the present invention are described in detail below with references to the following drawings.

FIG. ILLUSTRATION 1 is the rear view of the invention.

FIG. ILLUSTRATION 2 is the front view of the invention.

FIG. ILLUSTRATION 3 is an electrical schematic of the invention showing the circuit idle.

FIG. ILLUSTRATION 4 is an electrical schematic of the invention showing the circuit with the jukebox’s back menu button pressed.

FIG. ILLUSTRATION 5 is an electrical schematic of the invention showing the circuit when the jukebox’s forward menu button is pressed.

FIG. ILLUSTRATION 6 is an electrical schematic showing Central Processing Unit connections.

FIG. ILLUSTRATION 7 is an electrical schematic showing Video Driver and Control Board Connections

FIG. ILLUSTRATION 8 is an electrical schematic showing power supplies.

### DETAILED DESCRIPTION OF THE PREFERRED EMBODIMENT

FIG. ILLUSTRATION 1 shows the rear view of the invention with 1 the video driver board, 2 video control board, 3 central processing unit, 3A cooling fan, 4 relay 3, 5 relay 2, 6 relay 1 and 7 molex plug.

FIG. ILLUSTRATION 2 shows the front view of the invention with the video display 8.

FIG. ILLUSTRATION 3 depicts the electrical state when no buttons are pressed on the jukebox. 9 Feed from jukebox (Molex plug) not energized. 10 relay 1 coil not energized. 11 relay 2 coil not energized. 12 dry input to CPU trigger 1 is an open circuit. 13 dry input to CPU trigger 2 is an open circuit. 14 is electrical ground. 15 positive potential from CPU shown at 0 volts. 16 relay 3 coil shown non energized. 17 Molex plug output from jukebox shown 0 volts. 18 and 19 relay 3 contacts shown shorted, normal state. 10A diode for relay 1 shown 0 volts and 11A diode for relay 2 shown 0 volts.

FIG. ILLUSTRATION 4 when the back menu button on the jukebox is pressed, feed from jukebox 20 goes positive + 12 volts while Molex feed 27 is negative and energizes the coil on relay 2 22. Diode 21A blocks the voltage from energizing relay 1 coil 21. 23 CPU trigger one shorts and the CPU loads the previous .jpg file (menu page) unless it is already at the first page then it will scroll to the last menu page. At this time the CPU will also cause positive voltage to 26 for 0.5 seconds which will energize relay coil 3 28 for 0.5 seconds and open the electrical connection on the Molex plug 29 and 30 which will simulate the action of the original mechanical modules’ page turn to the jukeboxes’ processor.

FIG. ILLUSTRATION 5 when the forward menu button on the jukebox is pressed, feed from jukebox 38 goes positive + 12 volts while Molex feed 31 is negative and energizes the coil on relay 1 32. Diode 33A blocks the voltage from energizing relay 2 coil 33. 35 CPU trigger two shorts and the CPU loads the next .jpg file (menu page) unless it is already at the last page then it will scroll to the first menu page. At this time the CPU will also cause positive voltage to 37 for 0.5 seconds which will energize relay coil 3 40 for 0.5 seconds and open the electrical connection on the Molex plug 39 which will simulate the action of the original mechanical modules’ page turn to the jukeboxes’ processor.

FIG. ILLUSTRATION 6 central processing unit (CPU) connections are 41 negative output to relay 3. 42 positive output to relay 3. 43 CPU trigger 1. 44 CPU trigger 2. 45 USB drive stores menus, removeable to update menus. 46 HDMI cable to video driver board. 47 CPU ( Central Processing Unit) 48 Ground from power supply plug. 49 Power supply positive voltage. 50 fan to cool CPU. 51 positive voltage to fan. 52 negative voltage to fan.

FIG. ILLUSTRATION 7 53 video driver board. 54 Video output to display (monitor). 55 connection to video control board. 56 cable to video control board. 57 cable to display. 58 video control board. 59 HDMI input from CPU. 60 negative power supply input to CPU cooling fan. 61 positive power supply input to CPU cooling fan. 62 CPU cooling fan.

FIG. ILLUSTRATION 8 63 power supply for video driver board 12 vdc output. 64 power supply for CPU 5 vdc output.

### RELATIONSHIP BETWEEN THE PARTS OF THE INVENTION

The relationships are as described in the illustrations and more specifically, the jukebox has an existing forward and back menu button. Upon initial power up of the jukebox, both power supplies FIG. ILLUSTRATION 8 63 & 64 provide power to the CPU and video display. The video display shows the first menu for the compact discs 00 and 01 (if using the sample template) or a custom user first page.

When the forward menu button is pressed the jukebox sends voltage thru the Molex plug causing one of the inventions relays to energize and make a momentary contact closure. The CPU is running a custom script that sees the closure and advances to the next stored menu page on the USB drive which it sends via HDMI to the video driver board and to the display. Upon a page change the CPU also opens the input circuit on the Molex plug to let the jukebox logic know the page turned. This will continue each time the forward menu button is pressed on the jukebox until the last menu is reached then it will start over and display the first page.

The relationships are similar when the back button is pressed except the jukebox sends out a reverse voltage on the Molex plug and a different input is actuated on the CPU which makes it decrement the menu pages by one until the first one is reached. If the back button is pressed again, it will then go to the very last page.

The USB FIG. ILLUSTRATION 6 45 contains menu templates that the user can edit to create artist and track titles. The USB can be physically removed and edited using freely available software.

### DETAILS OF OPERATION AND FUNCTION

As described previously but more detailed, the invention replaces the existing mechanical module supplied with many popular jukeboxes. The jukebox contains this module and it clips into place and plugs into a Molex plug. Users must remove the module to update paper menus. The invention is inserted into the place of the module and plugs into the jukebox’s Molex plug without any modifications. The invention simulates the actions of the OEM module to make the jukebox logic think the OEM module is reacting as normal.

1. A menu display that is more readable and can display all available selections/tracks on a compact disc contained in the jukebox.

2. Users can create and customize the menus including backgrounds to conform to their own tastes and requirements.

3. A more responsive display system to the jukebox’s forward and back buttons.

4. Removes the chance of the drive belt breaking, stretching or mechanism malfunctions.

5. Directly replaces the existing mechanical module without any modification or rewiring of the jukebox.

6. Allows the existing jukebox menu buttons to control the invention.

7. Allows users to update the menu content through removeable media or wirelessly transmitted data.

8. Allows users to update menu (selections/tracks) without removing the module as was required with the mechanical one.

9. Other objects and advantages will appear from the detailed description and drawings enclosed herein.
